(19) United States
(12) Patent Application Publication
(10) Pub. No.: US 2013/0122147 A1
(43) Pub. Date: May 16, 2013

(54) METHODS FOR ENHANCING THE PALATABILITY OF COMESTIBLE COMPOSITIONS

(71) Applicants: Delphine Chaillot Tissot-Favre, Oakville, MO (US); Yuanlong Pan, Chesterfield, MO (US); Sandeep Bhatnagar, Ballwin, MO (US); Manuel Felipe Leyva, Bogata (CO); Sandra Lyn, St. Louis, MO (US)

(72) Inventors: Delphine Chaillot Tissot-Favre, Oakville, MO (US); Yuanlong Pan, Chesterfield, MO (US); Sandeep Bhatnagar, Ballwin, MO (US); Manuel Felipe Leyva, Bogata (CO); Sandra Lyn, St. Louis, MO (US)

(21) Appl. No.: 13/582,181

(22) PCT Filed: Mar. 18, 2011
(86) PCT No.: PCT/US11/00514

§ 371 Date: Jan. 9, 2013

Related U.S. Application Data
(60) Provisional application No. 61/340,924, filed on Mar. 24, 2010.

(51) Int. Cl. A23K 1/16

(52) U.S. Cl. CPC A23K 1/164
USPC 426/61; 426/650; 426/71

(57) ABSTRACT

The invention provides methods for enhancing the palatability of comestible compositions by combining the comestible compositions with a palatability enhancing amount of one or more fatty acid alkanolamides and the compositions produced by such methods.

### CROSS REFERENCE TO RELATED APPLICATIONS

This application is a national stage application under 35 U.S.C. §371 of PCT/US2011/000514 filed Mar. 18, 2011, which claims priority to U.S. Provisional Application Ser. No. 61/340,924 filed Mar. 24, 2010, the disclosures of which are incorporated herein by reference.

### BACKGROUND OF THE INVENTION

1. Field of the Invention

The invention relates generally to methods for enhancing palatability and particularly to methods for using fatty acid alkanolamides for enhancing the palatability of comestible compositions.

2. Description of Related Art

Generally, comestible compositions are designed to satisfy one or more taste or nutritional requirements for an animal. In some cases, such compositions are designed to be a “complete and balanced” food that provides all known nutritional requirements for the animal, e.g., many dog and cat foods. Often, when comestible compositions are formulated to satisfy nutritional requirements, the palatability of the compositions is less than desirable. Regardless of the formulation and actual nutritional content, if an animal will not consume a comestible composition, or does not consume the composition in sufficient quantities, the animal's nutritional needs will not be adequately met. Also, having palatable comestible compositions may provide benefits that go beyond an animal's purely physical or nutritional needs, e.g., reduction of stress hormones and a general feeling of health and wellness.

There are various ways of enhancing the palatability of comestible compositions. Addition of one or more ingredients that provide an appealing aroma or flavor can increase palatability. Ingredients that affect food qualities such as aroma, flavor, texture, or mouthfeel, can also affect palatability. It is known that, for some compositions, increasing sweetness or increasing fat or salt content can enhance palatability for some animals. Flavor enhancers, such as glutamic acid or its salts and various nucleotide or ribonucleotide compounds are known in the art to be palatability enhancers.

There are many known specific methods and compositions useful for enhancing the palatability. For example, US20080085350A1 discloses a method for producing a palatability enhancer for a companion animal food product, wherein the method includes combining at least one aroma chemical selected from 2-methylfuran, 2-methylpyrrole, 2-methyl-thiophene and dimethyl disulfide with an animal or vegetarian digest composition. US20050276881A1 discloses a catnip palatability enhancer comprising nepetalactone in form of catnip, catnip oil, matatabi, extract of matatabi, nepetalactone, and/or active analog of nepetalactone. US20010002272A1 discloses enhancing the palatability of extruded pet foods using tetrasodium pyrophosphate. US20050037108A1 discloses palatability enhancers containing tetrapotassium pyrophosphate and additional ingredients selected from animal by-products, microbial proteins, dairy by-products, amino acids (AA). U.S. Pat. No. 7,329,426 discloses the preparation of a palatability enhancer for animal food by cooking a liquefied mixture of triglyceride molecules from plant or animal source, mixed with at least one non-cellular donor compound as donor of sulfur or nitrogen.

Fatty acid alkanolamides are compounds containing a fatty acid moiety linked to alkanolamine. These compounds are part of a family of lipids that are generally found in plant and animal tissues. Numerous fatty acid alkanolamides and fatty acid ethanolamides are known in the art, e.g., the compounds disclosed in U.S. Pat. No. 6,911,474 and WO005115370A2. Two common fatty acid ethanolamides are anandamide (N-arachidonoyl-ethanolamine) and N-oleoyl-ethanolamide (OEA). U.S. Pat. No. 6,911,474, US20050154064A1, and US2005187254A1 disclose using fatty acid alkanolamides and their homologs and analogs to reduce body fat, reduce food consumption, and modulate lipid metabolism. WO08040756A1 discloses the use of anandamide for the manufacture of a nutraceutical for oral intake preferably a medicament for reducing appetite, giving a satiety effect, preventing or reducing inflammatory bowel disease, or preventing or reducing irritable bowel syndrome. However, the references do not disclose that such compounds affect palatability.

Even though there are many known methods and compositions useful for enhancing the palatability, there is always a need for new methods and compositions that make foods and other comestible compositions more palatable.

### SUMMARY OF THE INVENTION

It is, therefore, an object of the present invention to provide methods for enhancing the palatability of comestible compositions.

It is another object of the invention to provide comestible compositions having enhanced palatability.

It is another object of the invention to provide methods for ensuring compliance with a prescribed dietary plan.

One or more of these or other objects are achieved using novel methods for enhancing the palatability of comestible compositions such as foods, dietary supplements, medicaments, or other edible materials. The methods comprise combining the comestible compositions with a palatability enhancing amount of one or more fatty acid alkanolamides.

Other and further objects, features, and advantages of the present invention will be readily apparent to those skilled in the art.

### DETAILED DESCRIPTION OF THE INVENTION

### Definitions

The term “animal” means any animal that may choose a comestible composition based upon its palatability, including human, avian, bovine, canine, equine, feline, hicrine, lupine, murine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

The term “fatty acid alkanolamides” means one or more fatty acid alkanolamides and their analogs, homologs, precursors, prodrugs, or combinations thereof.

The term “N-oleoyl-ethanolamide” means N-oleoyl-ethanolamide and its analogs, homologs, precursors, prodrugs, or combinations thereof.

The term “palatability” refers to a quality of a comestible composition such as a food, food supplement, food additive, dietary supplement, medicament, snack, treat, or the like that makes it appealing or pleasing to one or more of an animal's senses, particularly the senses of taste and smell. Accordingly, palatability is determined subjectively. As used herein, whenever an animal shows a preference for one of two or more comestible compositions, the preferred comestible composition has greater “palatability.” For companion animals and other non-human animals, the relative palatability of one comestible composition compared to one or more other comestible composition can be determined using methods known in the art, e.g., in side-by-side, free-choice comparisons using relative consumption of the compositions or other appropriate measures of preference indicative of palatability.

The skilled artisan will appreciate that various aspects or phases of “palatability” can be considered both independently and interdependently. For example, “initial appeal,” “continued consumption palatability,” and “repeated presentation palatability” can all be considered. “Initial appeal” is an aspect of palatability that induces an animal to initially taste or try a food, dietary supplement, or medicament. “Continued consumption palatability” is an aspect of palatability that induces an animal to continue consuming a product that has been initially only tasted or tried. “Repeated presentation palatability” or “repeated feeding palatability” is an aspect of palatability evident when a food composition, dietary supplement, or medicament, which has previously been both tasted and consumed, is presented repeatedly to the animal for consumption over time. For example, a complete and balanced food composition that is fed daily to an animal will hopefully provide palatability for each repeated presentation such that the animal continues to consume adequate quantities of the food.

The term “palatability enhancer” means any compound, composition, formulation, or other material useful for enhancing the palatability of a comestible composition such as a food composition, dietary supplement, medicament, snack, treat, or the like. Palatability enhancers enhance palatability at any one or more of the aspects of palatability. Thus, such palatability enhancers may contribute to initial appeal, continued consumption, or repeated presentation aspects of palatability, or any combinations thereof. Examples of palatability enhancers include fats (e.g., tallow), flavors, aromas, extracts, digests, and the like.

The term “animal digest” means material which results from chemical and/or enzymatic hydrolysis of clean, undecomposed animal tissue. In certain embodiments, “animal digest” as used herein, is fully consistent with the definition of animal digest promulgated by the Association Of American Feed Control Officials, Inc. (AAFCO). Animal digest is preferably derived from animal tissues, including cold-blooded marine animals, excluding hair, horns, teeth, hooves, and feathers. The skilled artisan will appreciate that while such tissues are not preferred, trace amounts might be found unavoidably even under good manufacturing practices. Also not included are visceral contents or foreign or fecal matter, although trace contaminant amounts are sometimes present. When an animal digest is dried, it may be referred to as “dried animal digest.” Animal digests in accordance herewith are suitable for use in food or feed compositions. Specifically included are (1) Digest of Beef (or Poultry, Pork, Lamb, Fish, etc): material from beef (poultry, pork, etc.) which results from chemical and/or enzymatic hydrolysis of clean and undecomposed tissue; (2) Digest of Beef (or Pork, Lamb, etc) By-Products: material from beef (poultry, pork, etc.) which results from chemical and/or enzymatic hydrolysis of clean and undecomposed tissue from non-rendered clean parts from cattle (pigs, lambs, fish, etc), other than meat, for example lungs, spleen, kidneys, brain, livers, blood, bone, partially-defatted low-temperature fatty tissue, and stomachs and intestines, freed of their contents; and (3) Digest of Poultry By-Products: material which results from chemical and/or enzymatic hydrolysis of clean and undecomposed tissue from non-rendered clean parts of carcasses of slaughtered poultry such as heads, feet, and viscera. As used herein “poultry” encompasses any species or kind of bird, preferably chicken, turkey, duck, or other food species.

The term “single package” means that the components of a kit are physically associated in or with one or more containers and considered a unit for manufacture, distribution, sale, or use. Containers include, but are not limited to, bags, boxes, cartons, bottles, packages such as shrink wrap packages, stapled or otherwise affixed components, or combinations thereof. A single package may be containers of individual fatty acid alkanolamides and comestible compositions physically associated such that they are considered a unit for manufacture, distribution, sale, or use.

The term “virtual package” means that the components of a kit are associated by directions on one or more physical or virtual kit components instructing the user how to obtain the other components, e.g., in a bag or other container containing one component and directions instructing the user to go to a website, contact a recorded message or a fax-back service, view a visual message, or contact a caregiver or instructor to obtain instructions on how to use the kit or safety or technical information about one or more components of a kit.

All percentages expressed herein are by weight of the composition on a dry matter basis unless specifically stated otherwise. The skilled artisan will appreciate that the term “dry matter basis” means that an ingredient's concentration or percentage in a composition is measured or determined after any free moisture in the composition has been removed.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a supplement”, “a method”, or “a food” includes a plurality of such “supplements”, “methods”, or “foods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides methods for enhancing the palatability of comestible compositions. The methods comprise combining the comestible compositions with a palatability enhancing amount of one or more fatty acid alkanolamides to produce comestible compositions having enhanced palatability. The invention is based upon the discovery that fatty acid alkanolamides are palatability enhancers effective for enhancing the palatability of comestible compositions. While fatty acid alkanolamides are known to affect satiety, the discovery that such compounds are palatability enhancers that are useful for enhancing the palatability of comestible compositions was surprising and unexpected.

The comestible compositions useful in the invention are any comestible compositions compatible with fatty acid alkanolamides. The comestible compositions can be food compositions, food additives, snacks, treats, edible toys, pharmaceutical compositions, nutraceutical compositions, medicaments, and the like and can have any ingredients suitable for consumption by animals, e.g., proteins, fats, carbohydrates, fibers, and the like. In one preferred embodiment, the comestible compositions are food compositions. In another, the comestible compositions are dietary supplements.

The fatty acid alkanolamides useful in the invention are any fatty acid alkanolamides that enhance the palatability of comestible composition. Preferably, the fatty acid alkanolamides are fatty acid ethanolamides. Most preferably, the fatty acid alkanolamides are N-acyl fatty acid ethanolamides. In various embodiments, the fatty acid alkanolamides are hydrolysis-resistant fatty acid alkanolamide analogs, hydrolysis-resistant fatty acid ethanolamide analogs, or hydrolysis-resistant N-oleoyl-ethanolamide analogs such as (Z)-(R)-9-octadecenamide, N-(2-hydroxyethyl, 1-methyl). In a preferred embodiment, the fatty acid alkanolamide is N-oleoyl-ethanolamide.

The fatty acid alkanolamides are combined with the comestible compositions using any suitable method, e.g., mixing the fatty acid alkanolamides with one or more ingredients used to produce the comestible compositions, mixing the fatty acid alkanolamides into the comestible compositions during any stage of the manufacturing process, or applying the fatty acid alkanolamides to the comestible compositions after they are manufactured.

In one embodiment, combining the fatty acid alkanolamides with the comestible composition comprises topically applying the fatty acid alkanolamides onto the comestible composition. Topical application can be achieved using various methods known in the art, including spraying, enrobing, dipping, and liquid, dry or powder coating, or the like. In various embodiments, the fatty acid alkanolamides are applied to part or all of the surface of the composition. In some embodiments, coatings or other surface or topical applications are preferred because of the ease of application and the versatility of applications for comestible compositions such as food compositions, dietary supplements, snacks, treats, edible toys, or medicaments. In these embodiments, the proximity of a coating or surface application maximizes the palatability enhancing properties of the fatty acid alkanolamides. Rather than mixing the fatty acid alkanolamides with all or part of the comestible composition, the fatty acid alkanolamides are concentrated on the surface where they interact with the animal's sensory systems, e.g., taste buds, olfactory tissues, and the like. Generally, this method also allows for the use of a smaller amount of the fatty acid alkanolamides to get the same palatability affect that would be obtained if the fatty acid alkanolamides were mixed into the compositions. In other embodiments, the fatty acid alkanolamides are homogeneously distributed within the comestible compositions. In other embodiments, the fatty acid alkanolamides are non-homogeneously distributed within the comestible compositions.

In some embodiments, the fatty acid alkanolamides can be admixed with or enclosed within a carrier before being combined with the comestible compositions. For example, the fatty acid alkanolamides may be encapsulated in carrier that protects the fatty acid alkanolamides from adverse environmental or manufacturing conditions when combining with the comestible composition or during further processing of the combination. Many such carriers are known to skilled artisans. Examples include corn syrup solids, mannitol, calcium carbonate, whey protein isolate, gluten, pre-gelatinized starches, cellulose fiber, carbohydrates, gelatin, flour, grain, bran, or combinations thereof.

Generally, the fatty acid alkanolamides are combined with the comestible compositions such that the fatty acid alkanolamides comprise from about 0.0001 to about 20% of the comestible compositions having enhanced palatability. In various embodiments, the fatty acid alkanolamide comprises from about 0.001% to about 20%; preferably from about 0.01 to about 20%; more preferably from about 0.05 to about 20%; and most preferably from about 0.1 to about 20% of the compositions. In other embodiments, the fatty acid alkanolamides are combined with the comestible compositions such that the fatty acid alkanolamides comprise from about 0.01 to about 15% of the comestible compositions having enhanced palatability. In further embodiments, the fatty acid alkanolamide comprises from about 0.02% to about 10%; preferably from about 0.05 to about 8%; more preferably from about 0.05 to about 5%; and most preferably from about 0.1 to about 3% of the compositions. In additional embodiments, the methods further comprise combining the comestible composition with one or more different palatability enhancers as described herein, e.g., an animal digest.

In other embodiments, the methods further comprise combining the comestible composition with one or more prebiotics, probiotics, or combinations thereof as described herein, e.g., Enterococcus faecium SF68.

The methods of the invention can be accomplished by combining the elements that comprise the comestible composition having enhanced palatability in any suitable order, e.g., the comestible compositions can be combined with fatty acid alkanolamides and subsequently combined with different palatability enhancers, the comestible compositions can be combined with different palatability enhancers and subsequently combined with the fatty acid alkanolamides, the different palatability enhancers and the fatty acid alkanolamides can be combined and subsequently combined with the comestible compositions, the probiotics and prebiotics can be added before the comestible compositions are combined with the palatability enhancers or vice versa, and the like.

In another aspect, the invention provides comestible compositions made using the methods of the invention.

In another aspect, the invention provides comestible compositions having enhanced palatability. The comestible compositions comprise one or more comestible ingredients suitable for consumption by an animal and a palatability enhancing amount of one or more fatty acid alkanolamides. The comestible compositions containing the fatty acid alkanolamides have been shown to have enhanced palatability compared to comestible compositions comprising the comestible ingredients alone.

In various embodiments, the comestible compositions having enhanced palatability comprise from about 0.0001 to about 20% fatty acid alkanolamides. In other embodiments, the fatty acid alkanolamide comprises from about 0.01% to about 15%; preferably from about 0.02 to about 10%; more preferably from about 0.05 to about 5%; and most preferably from about 0.1 to about 3% of the compositions. In one preferred embodiment, the fatty acid alkanolamide comprises from about 0.4% to about 1% of the compositions.

As stated herein, the comestible compositions can have any form and have any ingredients suitable for consumption by animals. In certain embodiments, the comestible compositions are food compositions. The content of the food compositions will depend on factors such as the animal's species, age, size, weight, health, and the like. A skilled artisan can formulate a food composition that is appropriate for the animal and compatible with the fatty acid alkanolamides of the invention. In various embodiments, the food compositions comprise one or more of protein, fat, carbohydrate, moisture, and fiber.

In some embodiments, the food compositions contain from about 15% to about 50% crude protein. The crude protein material may comprise vegetable proteins such as soybean meal, soy protein concentrate, corn gluten meal, wheat gluten, cottonseed, and peanut meal, or animal proteins such as casein, albumin, and meat protein. Examples of meat protein useful herein include pork, lamb, equine, poultry, fish, and mixtures thereof.

In other embodiments, the food compositions comprise from about 5% to about 40% fat, generally with about 5 to 50% of energy represented by lipids. Examples of suitable fats include animal fats and vegetable fats. Preferably the fat source is an animal fat source such as tallow. Vegetable oils such as corn oil, sunflower oil, safflower oil, rape seed oil, soy bean oil, olive oil and other oils rich in monounsaturated and polyunsaturated fatty acids, may also be used.

In further embodiments, the food compositions comprise from about 15% to about 60% carbohydrate. Examples of suitable carbohydrates include grains or cereals such as rice, corn, milo, sorghum, alfalfa, barley, soybeans, canola, oats, wheat, and mixtures thereof. The compositions may also optionally comprise other materials such as dried whey and other dairy by-products.

Generally, the moisture content of the food compositions varies depending on the nature of the composition. For companion animals, the compositions may be dry compositions (e.g., kibble), semi-moist compositions, wet compositions, or any mixture thereof. In this embodiment, the pet food may be a “wet food”, “dry food”, or food of “intermediate moisture” content. “Wet food” describes pet foods that are typically sold in cans or foil bags and has a moisture content typically in the range of about 70% to about 90%. “Dry food” describes pet food that is of a similar composition to wet food but contains a limited moisture content typically in the range of about 5% to about 15% or 20% (typically in the form or small biscuit-like kibbles). In one preferred embodiment, the compositions have moisture content from about 5% to about 20%. Dry food compositions include a variety of foods of various moisture contents, such that they are relatively shelf-stable and resistant to microbial or fungal deterioration or contamination. Also preferred are dry compositions that are extruded food products such as pet foods or snack foods for either humans or companion animals.

In various embodiments, the food compositions comprise one or more fiber sources. The term “fiber” includes all sources of “bulk” in the food whether digestible or indigestible, soluble or insoluble, fermentable or nonfermentable. Preferred fibers are from plant sources such as marine plants but microbial sources of fiber may also be used. A variety of soluble or insoluble fibers may be utilized, as will be known to those of ordinary skill in the art. The fiber source can be beet pulp (from sugar beet), gum arabic, gum talha, psyllium, rice bran, carob bean gum, citrus pulp, pectin, fructooligosaccharide, short chain oligofructose, mannanoligofructose, soy fiber, arabinogalactan, galactooligosaccharide, arabinoxylan, or mixtures thereof. Alternatively, the fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may also be incorporated into the composition to aid in the enhancement of the benefit provided by the present invention to the immune system of an animal.

In some embodiments, the ash content of the food compositions ranges from less than 1% to about 15%, preferably from about 5% to about 10%.

In preferred embodiments, the comestible compositions comprise fatty acid alkanolamides in amounts described herein and from about 15% to about 50% protein, from about 5% to about 40% fat, and from about 15% to about 60% carbohydrate. Preferably, the compositions have an ash content of from about 5% to about 10% and a moisture content of about 5% to about 20%.

In certain embodiments, the food compositions are formulated to provide “complete and balanced” nutrition for an animal, preferably a companion animal, according to standards established by the Association of American Feed Control Officials (“AAFCO”). In other embodiments, the food compositions are pet food compositions. Such food composition can be fed solely or blended in various proportions with other food ingredients.

In certain embodiments, the food compositions are nutraceutical compositions.

In some embodiments, the comestible compositions are dietary supplements. The dietary supplements may have any suitable form such as a gravy, drinking water, beverage, yogurt, powder, granule, paste, suspension, chew, morsel, treat, snack, pellet, pill, capsule, tablet, sachet, or any other suitable delivery form. In one embodiment, the comestible composition is a yogurt suitable for consumption by humans. The dietary supplements can comprise fatty acid alkanolamides and optional compounds such as vitamins, preservatives, probiotics, prebiotics, and antioxidants. This permits the supplements to be administered to the animal in small amounts, or in the alternative, can be diluted before administration to an animal. The dietary supplements may require admixing with a comestible composition or with water or other diluent prior to administration to the animal. When supplied is a sachet, the comestible compositions can be combined with a food or beverage just before consumption. When the comestible compositions are dietary supplements, the fatty acid alkanolamides comprises from about 1 to about 100% of the supplement, preferably from about 3 to about 75%, more preferably from about 5 to about 50%. Such dietary supplements can be based on the food compositions described herein or formulated using ingredients and methods known to skilled artisans.

In some embodiments, the comestible compositions are pharmaceutical compositions. The pharmaceutical compositions comprise fatty acid alkanolamides and one or more pharmaceutically acceptable carriers, diluents, or excipients. Generally, pharmaceutical compositions are prepared by admixing a compound or composition with excipients, buffers, binders, plasticizers, colorants, diluents, compressing agents, lubricants, flavorants, moistening agents, and the like, including other ingredients known to skilled artisans to be useful for producing pharmaceuticals and formulating compositions that are suitable for administration to an animal as pharmaceuticals. When the comestible compositions are pharmaceutical compositions, the fatty acid alkanolamides comprises from about 1 to about 99% of the compositions, preferably from about 3 to about 60%, more preferably from about 5 to about 50%. In a preferred embodiment, the comestible compositions are pharmaceutical compositions formulated for companion animals such as dogs and cats.

In a most preferred embodiment, the pharmaceutical compositions are administered to the animal before a meal. The fatty acid alkanolamides increase the palatability of the pharmaceutical compositions and increase the likelihood that the animal will voluntary consume and benefit from the pharmaceutical compositions. Further, the fatty acid alkanolamides increase satiety so that the animal will consume less food in a subsequent meal. Generally, such pharmaceutical compositions are administered from 0.2 to 4 hours before the anticipated meal but can be administered as needed to benefit the animal.

In other embodiments, the comestible compositions further comprise one or more different palatability enhancers. These palatability enhancers are any palatability enhancers that increase the palatability of the comestible compositions and are compatible with the fatty acid alkanolamides of the invention and the comestible compositions. Many such palatability enhancers are known in the art, e.g., animal digests, animal fats, and inorganic pyrophosphates. Generally, the different palatability enhancers are combined with the comestible compositions such that the different palatability enhancers comprise from about 0.1 to about 25% of the comestible compositions having enhanced palatability. In various embodiments, the different palatability enhancers comprise from about 0.1% to about 20%; preferably from about 0.5 to about 15%; more preferably from about 1 to about 10%; and most preferably from about 2 to about 8% of the compositions.

In various embodiments, the comestible compositions further comprise one or more probiotics. In various embodiments, the compositions contain (1) one or more killed or inactivated probiotics, (2) components of the killed or inactivated probiotics that promote health benefits similar to or the same as the live probiotics, or (3) combinations thereof. The probiotics or their components can be integrated into the compositions (e.g., uniformly or non-uniformly distributed in the composition) or applied to the food compositions (e.g., topically applied with or without a carrier). In one embodiment, the probiotics are encapsulated in a carrier. Typical probiotics include, but are not limited to, probiotic strains selected from Lactobacilli, Bifidobacteria, or Enterococci, e.g., Lactobacillus reuteii, Lactobacillus acidophilus, Lactobacillus animalis, Lactobacillus ruminis, Lactobacillus johnsonii, Lactobacillus casei, Lactobacillus paracasei, Lactobacillus rhamnosus, Lactobacillus fermentum, and Bifidobacterium sp., Enterococcus faecium and Enterococcus sp. In some embodiments, the probiotic strain is selected from the group consisting of Lactobacillus reuteri (NCC2581; CNCM 1-2448), Lactobacillus reuteri (NCC2592; CNCM I-2450), Lactobacillus rhamnosus (NCC2583; CNCM 1-2449), Lactobacillus reuteri (NCC2603; CNCM I-2451), Lactobacillus reuteri (NCC2613; CNCM 1-2452), Lactobacillus acidophilus (NCC2628; CNCM I-2453), Bifidobacterium adolescentis (e.g. NCC2627), Bifidobacterium sp. NCC2657 or Enterococcus faecium SF68 (NCIMB 10415). The compositions contain probiotics in amounts sufficient to supply from about 10⁴ to about 10¹² cfu/animal/day, preferably from 10⁵ to about 10¹¹ cfu/animal/day, most preferably from 10⁷ to 10¹⁰ cfu/animal/day. When the probiotics are killed or inactivated, the amount of killed or inactivated probiotics or their components should produce a similar beneficial effect as the live microorganisms. Many such probiotics and their benefits are known to skilled artisans, e.g., EP1213970B1, EP1143806B1, U.S. Pat. No. 7,189,390, EP1482811B1, EP1296565B1, and U.S. Pat. No. 6,929,793.

In various embodiments, the comestible compositions further comprise one or more prebiotics, e.g., fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In certain embodiments, the prebiotic is chicory, chicory root extract, aleurone, inulin, or combinations thereof. The prebiotics are integrated into the compositions as described herein, e.g., uniformly or non-uniformly distributed in the composition) or applied to the food compositions (e.g., topically applied with or without a carrier. Generally, prebiotics are administered in amounts sufficient to positively stimulate the healthy microflora in the gut. Typical amounts are from about 1 to about 10 grams per serving or from about 5 to about 40% of the recommended daily dietary fiber for an animal.

In various embodiments, the comestible compositions further comprise a combination of one or more probiotics and one or more prebiotics.

In another aspect, the invention provides a palatability enhancer comprising a palatability enhancing amount or one or more fatty acid alkanolamides. In various embodiments, the palatability enhancer further comprises one or more different palatability enhancers.

Generally, the palatability enhancer comprises from about 1 to about 99% of one or more fatty acid alkanolamides and from about 99 to about 1% of one or more different palatability enhancers, preferably from about 2 to about 80%, more preferably from about 5 to about 50%. In one embodiment, such palatability enhancer comprises from about 1 to about 40% of one or more fatty acid alkanolamides and from about 99 to about 60% of the different palatability enhancers. In a preferred embodiment, the different palatability enhancer is an animal digest. In various embodiments, the palatability enhancers further comprise one or more prebiotics, probiotics, or combinations thereof.

In various embodiments, the comestible compositions comprise additional ingredients such as vitamins, minerals, amino acids, nucleic acids, fillers, binding agents, flavors, stabilizers, emulsifiers, sweeteners, colorants (e.g., titanium dioxide), buffers, salts, coatings, condiments, preservatives, and the like known to skilled artisans. Non-limiting examples of supplementary minerals include calcium, phosphorous, potassium, sodium, iron, chloride, boron, copper, zinc, magnesium, manganese, iodine, selenium, and the like. Non-limiting examples of supplementary vitamins include vitamin A, any of the B vitamins, vitamin C, vitamin D, vitamin E, and vitamin K, including various salts, esters, or other derivatives of the foregoing. Additional dietary supplements may also be included, for example, any form of niacin, pantothenic acid, inulin, folic acid, biotin, amino acids, and the like, as well as salts and derivatives thereof. Stabilizers include substances that tend to increase the shelf life of the composition such as preservatives, synergists and sequestrants, packaging gases, emulsifiers, thickeners, and gelling agents. Examples of emulsifiers and/or thickening agents include gelatin, cellulose ethers, starch, starch esters, starch ethers, and modified starches. Selection of the ingredients and their amounts is known to skilled artisans. Specific amounts for each additional ingredient will depend on a variety of factors such as the ingredient included in the composition; the species of animal; the animal's age, body weight, general health, sex, and diet; the animal's consumption rate; the purpose for which the food composition is being administered to the animal; and the like. Therefore, the component and ingredient amounts may vary widely and may deviate from the preferred proportions described herein. In such embodiments, such additional ingredients typically comprise from about 0.0001 to about 20% of the food composition, preferably from about 0.001 to about 15%.

In general, a skilled artisan can determine the appropriate amount of fatty acid alkanolamides, food ingredients, vitamins, minerals, probiotics, prebiotics, antioxidants, or other ingredients to be use to make a comestible composition. Such artisan can consider the animal's species, age, size, weight, health, and the like in determining how best to formulate a particular comestible composition comprising fatty acid alkanolamides and other ingredients. Other factors that may be considered include the type of composition (e.g., pet comestible composition), the desired amount of each component, the average consumption of specific types of compositions by different animals (e.g., based on species, body weight, activity/energy demands, and the like), and the manufacturing requirements for the composition.

In another aspect, the present invention provides packages comprising one or more fatty acid alkanolamides and a label affixed to the package containing a word or words, picture, design, acronym, slogan, phrase, or other device, or combinations thereof that indicates that the fatty acid alkanolamides are useful for enhancing the palatability of comestible compositions. In one embodiment, the packages comprise (1) one or more fatty acid alkanolamides, (2) one or more comestible ingredients suitable for consumption by an animal, and (3) a label affixed to the package containing a word or words, picture, design, acronym, slogan, phrase, or other device, or combinations thereof that indicates that the fatty acid alkanolamides are useful for enhancing the palatability of comestible compositions.

Typically, such device comprises the words “enhanced palatability”, “better tasting food”, “new and improved palatability”, or an equivalent expression printed on the package. Any package or packaging material suitable for containing the composition is useful in the invention, e.g., a sachet, bag, box, bottle, can, pouch, and the like manufactured from paper, plastic, foil, metal, and the like. In a preferred embodiment, the package contains a comestible composition adapted for a particular animal such as a human, canine, or feline, as appropriate for the label, preferably a companion animal comestible composition for dogs or cats. In a preferred embodiment, the package is a sachet comprising fatty acid alkanolamides.

In a further aspect, the present invention provides kits suitable for enhancing the palatability of comestible compositions. The kits comprise in separate containers in a single package or in separate containers in a virtual package, as appropriate for the kit component, one or more fatty acid alkanolamides and one or more of (1) one or more comestible ingredients suitable for consumption by an animal; (2) one or more probiotics, e.g., Enterococcus faecium SF68; (3) one or more prebiotics, e.g., chicory, chicory root extract, aleurone, inulin, or combinations thereof.; (4) one or more different palatability enhancers, e.g., an animal digest; (5) instructions for how to combine fatty acid alkanolamides and other kit components to produce a comestible composition having enhanced palatability; (6) a device useful for combining the kit components to produce comestible compositions having enhanced palatability, e.g., a spoon or other application device; and (7) a device for administering the prepared comestible compositions to an animal, e.g., a bowl or other container. In a preferred embodiment, the fatty acid alkanolamides are in a sachet.

When the kit comprises a virtual package, the kit is limited to instructions in a virtual environment in combination with one or more physical kit components.

The kit contains fatty acid alkanolamides and other components in amounts sufficient to enhance palatability. Typically, fatty acid alkanolamides and the other suitable kit components, e.g., food ingredients, are admixed just prior to consumption by an animal. The kits may contain the kit components in any of various combinations and/or mixtures. In one embodiment, the kit contains a packet or sachet containing fatty acid alkanolamides and a container of food for consumption by an animal. In this embodiment, the fatty acid alkanolamides are typically combined with the ingredients just before consumption. The kit may contain various additional items such as a device for mixing fatty acid alkanolamides and other ingredients or a device for containing the admixture, e.g., a food bowl. In another embodiment, fatty acid alkanolamides are mixed with additional nutritional supplements such as vitamins and minerals that promote good health in an animal. The components can be each provided in separate containers in a single package or in mixtures of various components in different packages.

In preferred embodiments, the kits comprise one or more fatty acid alkanolamides and one or more other ingredients suitable for consumption by an animal. Preferably such kits comprise instructions describing how to combine fatty acid alkanolamides with the other ingredients to form a comestible composition for consumption by the animal, generally by mixing fatty acid alkanolamides with the other ingredients or by applying fatty acid alkanolamides to the other ingredients, e.g. by sprinkling fatty acid alkanolamides on a comestible composition.

In another aspect, the invention provides a means for communicating information about or instructions for one or more of (1) using fatty acid alkanolamides for enhancing the palatability of comestible compositions; (2) admixing fatty acid alkanolamides and comestible ingredients to produce a comestible composition having enhanced palatability, e.g., food compositions, dietary supplements, and the like suitable for consumption by an animal; and (3) using the kits of the present invention to produce comestible compositions having enhanced palatability. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combinations thereof.

In another aspect, the invention provides methods for manufacturing a comestible composition having enhanced palatability comprising fatty acid alkanolamides and one or more other comestible ingredients suitable for consumption by an animal, e.g., one or more of protein, fat, carbohydrate, fiber, vitamins, minerals, probiotics, prebiotics, different palatability enhancers, and the like. The methods comprise combining one or more fatty acid alkanolamides and one or more comestible ingredients to produce a comestible composition having enhanced palatability when compared to a comestible composition containing the ingredients alone.

In some embodiments, the methods comprise admixing one or more comestible ingredients with fatty acid alkanolamides to produce comestible compositions having enhanced palatability. Alternatively, the methods comprise applying fatty acid alkanolamides alone or in conjunction or combination with other ingredients onto the comestible composition, e.g., as a coating or topping. The fatty acid alkanolamides can be added at any time during the manufacture and/or processing of the comestible composition. The comestible composition can be made according to any method suitable in the art.

In another aspect, the invention provides methods for ensuring compliance with a prescribed dietary plan. The methods comprise combining comestible compositions used in the prescribed dietary plan with a palatability enhancing amount of one or more fatty acid alkanolamides to produce comestible compositions having enhanced palatability. Most prescribed dietary plans rely on comestible compositions that are beneficial to the animal but are less palatable to the animal. Generally, such plans use less palatable ingredients produce the comestible compositions that accomplish the purpose of the dietary plan. As a result, the animals dislike the comestible compositions used in the plan and do not consume the compositions as needed or desired, e.g., an animal on a weight loss dietary plan may require a prescribed amount of food to promote weight loss while getting proper nutrition but the animal consumes less than the prescribed amount because the food is not palatable. As a result, the animals do not get the nutrition needed to maintain good health and wellness. Adding fatty acid alkanolamides increases the palatability of the compositions and ensures that the animal consumes the compositions in the amount needed to comply with the dietary plan.

For example, a weight management dietary plan often utilizes foods that are low in caloric content but are not very palatable to the animal, e.g., a comestible composition low in sugars and/or fats that helps reduce weight but is not very palatable. Or, the weight management plan may attempt to add to an animal's weight using unpalatable ingredients. Because of the lack of palatability, the animals often eat less than desired and lose weight but do not get proper nutrition. Further, animals on a dietary plan to increase weight may eat less that the prescribed amount because the food is less palatable. Similarly, dietary plans for various medical conditions such as diabetes, phenylketonuria (PKU), cancer, allergies, gastrointestinal tract impairments, Alzheimer's disease, conditions or diseases that interfere with chewing, conditions or diseases that interfere with chewing swallowing (e.g., dysphagia), conditions or diseases that require partial or complete enteral therapy, and the like may require dietary plans that use comestible compositions that are less palatable than typical comestible compositions because they require special ingredients, ingredients that are less palatable than desired.

In addition, medical foods that are specially formulated and intended for the dietary management of diseases or medical conditions (e.g., prevent or treat diseases or undesirable medical conditions) are often less palatable than non-medical foods, e.g., because of the ingredients used in the foods or the texture of the foods. Medical foods generally require ingredients that must meet the distinctive nutritional needs characteristic of a particular disease, but may not be very palatable. Using the palatability enhancers of the invention makes the food more palatable and ensures that the animal consumes the compositions in the desired amounts. In one embodiment, the medical food is a medical food used for the management of Alzheimer's disease based upon the use of medium chain triglycerides. Such medical foods are known to skilled artisans, e.g., Axona® Medical Food.

### EXAMPLES

The invention can be further illustrated by the following examples, although it will be understood that the examples are included merely for purposes of illustration and are not intended to limit the scope of the invention unless otherwise specifically indicated.

### Example 1

A pet food was produced using the ingredients shown in Table 1, Table 2, and Table 3. 2000 lbs of dry ingredient mix (Table 1) were fed into a preconditioner where about 540 lbs of ground chicken (ground and heated as in Table 2), 60 lbs of water and 60 lbs of steam were admixed. The resultant mixture was then fed into a single screw extruder with jackets for cooling or heating. Cooling water at room temperature was being constantly passed through the jackets. The screw in the extruder was rotated at 230 rpm. The mixture was thus mechanically worked within the extruder at a temperature of around 238° F. and pressure of about 250 to 1500 psig. The resultant dough like material was continuously passed through a die with 6 triangular shaped holes and cut using a rotating knife. Triangular shaped pieces of pet food thus obtained were dried to a moisture content of 8%. Dried pet food pieces were coated with Tallow with Flavor enhancers (Table 3). This food served as a control food for comparison to foods containing OEA.

### Example 2

A pet food was produced according to Example 1 except that 13.5 lbs of Tallow with Flavor was used and 1.0 lbs of OEA was added.

### Example 3

A pet food was produced according to Example 2 except that the Tallow with Flavor was replaced with 13.5 lbs of lard.

### Example 4

A pet food was produced according to Example 1 using the ingredients in Table 4 instead of the ingredients in Table 2.

### Example 5

A pet food was produced according to Example 4 except that except that 13.5 lbs of Tallow with Flavor was used and 1.0 lbs of OEA was added.

### Example 6

A pet food was produced according to Example 5 above except for Tallow was replaced with 13.5 lbs of lard.

### Example 7

A pet food was produced according to Example 1 but using the ingredients shown in Table 5, Table 6, and Table 7.

### Example 8

A pet food was produced according to Example 7 except that 240.1 lbs of corn whole yellow was used and 9.9 lbs of OEA was added.

### Palatability Tests

The pet foods in Examples 1 through 5 were tested for palatability and the results compared to determine if OEA enhanced the palatability of the test foods containing OEA. Palatability testing followed the industry standard protocol for assessing preference, i.e., the two-bowl choice test. The dogs were tested individually inside their kennels. The panels consisted of a mix of breeds, distributed as equally as possible. The dogs were at least 12 months of age and the sex distribution was as equal as possible within panels. A choice of two bowls each with the same amount food, the test and the control diets, was offered simultaneously. The maximum length of the time the products were offered to the dogs was 20 minutes. Water was available at all times via an automatic water system. Bowl assignment for the foods was always counterbalanced.

At the end of a test, food consumption for each pet food for each dog was determined by subtracting the amount of food remaining in the bowls from what was initially offered to the dogs. A dog's preference was determined based on which food was most consumed. A food was considered significantly preferred if the number of dogs preferring the food was significantly greater than the number of dogs preferring the other food as determined by the Sign Test with an alpha-level (type I error) of 0.05. The results are shown in Table 8. Referring to Table 8, the results clearly showed that OEA enhanced the palatability of the pet foods and it therefore clearly a palatability enhancer useful for enhancing the palatability of comestible compositions when combined with such compositions.

The pet foods in Examples 7 and 8 were tested for palatability using the methods given for Examples 1 through 5 and the results compared to determine if OEA enhanced the palatability of a food containing the OEA. The experiment was repeated twice. The results are shown in Table 9. Referring to Table 9, the results clearly showed that OEA enhanced the palatability of the pet food and is therefore clearly a palatability enhancer useful for enhancing the palatability of comestible compositions when combined with such compositions.

TABLE 1

| Ingredients | Amount (lbs) |
|---|---|
| Zinc Sulfate PF | 120.7 |
| AA Premix | 6 |
| Corn Whole Yellow | 280 |
| Corn Bran | 94 |
| Rice Brewers Milled | 440 |
| Wheat Whole | 430 |
| L-Lysine | 1 |
| Potassium Chloride | 16 |
| Corn Gluten Meal 60 | 299 |
| Vitamins | 2 |
| Egg Product Dried | 25 |
| Fish Meal | 72 |
| Poultry Byproduct Meal | 300 |
| Calcium Carbonate | 6 |
| Monocalcium Dicalcium Phosphate | 15 |
| Salt | 12 |
| Choline Chloride Liquid | 2 |
| Total | 2000 |

TABLE 2

| Ingredients | Amount (lbs) |
|---|---|
| Ground Chicken | 540 |
| Water | 60 |
| Steam | 60 |
| Total | 660 |

TABLE 3

| Ingredients | Amount (lbs) |
|---|---|
| Dried Pet food | 181.5 |
| Tallow with Flavor | 14.5 |
| Liquid Flavor Enhancer | 4 |
| Total | 200 |

TABLE 4

| Ingredients | Amount (lbs) |
|---|---|
| Ground Chicken | 538.6 |
| Lard | 59.8 |
| OEA | 1.6 |
| Steam | 60 |
| Total | 660 |

TABLE 5

| Ingredients | Amount (lbs) |
|---|---|
| Mineral Premix | 8 |
| Corn Whole Yellow | 250 |
| Corn Bran | 90 |
| Rice Brewers Milled | 420 |
| Wheat Whole | 420 |
| L-Lysine | 0.2 |
| Potassium Chloride | 14 |
| Corn Gluten Meal 60 | 320 |
| Vitamins | 5 |
| Egg Product Dried | 24 |
| Fish Meal | 74 |
| Poultry Byproduct Meal | 340 |
| Calcium Carbonate | 10 |
| Monocalcium Dicalcium Phosphate | 10 |
| Salt | 13 |
| Choline Chloride Liquid | 2 |
| Total | 2000 |

TABLE 6

| Ingredients | Amount (lbs) |
|---|---|
| Ground Chicken | 540 |
| Tallow | 60 |
| Steam | 60 |
| Total | 660 |

TABLE 7

| Ingredients | Amount (lbs) |
|---|---|
| Dried Pet food | 181.5 |
| Tallow with Flavor | 14.5 |
| Liquid Flavor Enhancer | 4 |
| Total | 200 |

TABLE 8

| | | | Number | % | |
|---|---|---|---|---|---|
| Palatability | % | OEA | of | Consumption | |
| Test | OEA | Application | Dogs | (OEA Food) | p-value |
| Ex 1 cf. Ex 2 | 0.50 | Tallow (coating) | 20 | 73 | <.005 |
| Ex 1 cf. Ex 3 | 0.50 | Lard (coating) | 20 | 77 | <.005 |
| Ex 1 cf. Ex 4 | 0.066 | Lard (slurry) | 20 | 84 | <.005 |
| Ex 1 cf. Ex 5 | 0.566 | Lard (slurry) & | 20 | 73 | <.005 |
| | | Tallow (coating) | | | |
| Ex 1 cf. Ex 6 | 0.566 | Lard (slurry) & | 20 | 81 | <.005 |
| | | Lard (coating) | | | |

TABLE 9

| | | | Number | % | |
|---|---|---|---|---|---|
| Palatability | % | OEA | of | Consumption | |
| Test | OEA | Application | Dogs | (OEA Food) | p-value |
| Ex 7 cf. Ex 8 | 0.41 | Meal (in basal) | 40 | 77 | <.005 |
| Ex 7 cf. Ex 8 | 0.41 | Meal (in basal) | 40 | 78 | <.005 |
| Ex 7 cf. Ex 8 | 0.41 | Meal (in basal) | 40 | 77 | <.005 |

“Ex” indicates a pet food from a numbered Example, e.g., Ex 1 means Example 1

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A method for enhancing the palatability of a comestible composition comprising combining the comestible composition with a palatability enhancing amount of one or more fatty acid alkanolamides to produce a comestible composition having enhanced palatability.

2. The method of claim 1 wherein the fatty acid alkanolamide is a fatty acid ethanolamide.

3. The method of claim 1 wherein the fatty acid alkanolamide is a N-acyl fatty acid ethanolamide.

4. The method of claim 1 wherein the fatty acid alkanolamide is a hydrolysis-resistant fatty acid alkanolamide analog.

5. The method of claim 1 wherein the fatty acid ethanolamide is N-oleoyl-ethanolamide.

6. The method of claim 1 wherein the fatty acid alkanolamide is (Z)-(R)-9-octadecenamide, N-(2-hydroxyethyl, 1-methyl).

7. The method of claim 1 wherein the comestible composition and fatty acid alkanolamides are combined by topically applying the fatty acid alkanolamides onto the comestible composition.

8. The method of claim 1 wherein the comestible composition and fatty acid alkanolamides are combined by homogeneously distributing the fatty acid alkanolamides within the comestible composition.

9. The method of claim 1 wherein the comestible composition and fatty acid alkanolamides are combined by non-homogeneously distributing the fatty acid alkanolamides within the comestible composition.

10. The method of claim 1 wherein the fatty acid alkanolamides comprise from about 0.0001 to about 20% of the comestible composition having enhanced palatability.

11. The method of claim 1 further comprising combining the comestible composition with one or more different palatability enhancers.

12. The method of claim 11 wherein the different palatability enhancer is an animal digest.

13. (canceled)

14. (canceled)

15. (canceled)

16. A comestible composition having enhanced palatability made using the method of claim 1.

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A palatability enhancer comprising a palatability enhancing amount of one or more fatty acid alkanolamides.

34. The palatability enhancer of claim 33 further comprising one or more different palatability enhancers.

35. The palatability enhancer of claim 34 comprising comprises from about 1 to about 99% of one or more fatty acid alkanolamides and from about 99 to about 1% of one or more different palatability enhancers.

36. The palatability enhancer of claim 35 wherein the different palatability enhancer is an animal digest.

37. (canceled)

38. (canceled)

39. (canceled)

40. The palatability enhancer of claim 34 further comprising one or more prebiotics, probiotics, or combinations thereof.

41. The palatability enhancer of claim 40 wherein the probiotic is Enterococcus faecium SF68.

42. The palatability enhancer of claim 40 wherein the prebiotic is chicory, chicory root extract, aleurone, inulin, or combinations thereof.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)
